(19) United States
(12) Patent Application Publication
(10) Pub. No.: US 2008/0204281 A1
(43) Pub. Date: Aug. 28, 2008

(54) Electronic key system and portable unit

(75) Inventors: Masahiro Sugiura, Takahama-city (JP); Hiromichi Naitoh, Okazaki-city (JP); Munenori Matsumoto, Kariya-city (JP); Noriaki Okada, Chiryu-city (JP); Shinichiro Kato, Kariya-city (JP); Tomoji Mabuchi, Nagoya-city (JP); Haruyuki Ikeo, Chiryu-city (JP); Masataka Okado, Chita-gun (JP); Kouichi Mizuno, Toyota-city (JP); Tomotsugu Sekine, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/071,215

(22) Filed: Feb. 19, 2008

(30) Foreign Application Priority Data
Feb. 28, 2007 (JP) 2007-49558

(51) Int. Cl. G08G 1/123

(52) U.S. Cl. 340/988

(57) ABSTRACT

An electronic key system includes an in-vehicle unit mounted in a vehicle and a portable unit. When a user leaves the vehicle, the in-vehicle unit requests information on a relative position of the vehicle relative to a landmark object near the vehicle from a vehicle navigation device and transmits received relative position information to the portable unit. The portable unit stores the received relative position information, and notifies of the stored relative position information according to a user's operation.

### CROSS REFERENCE TO RELATED APPLICATION

The presented application is based on and incorporates herein by reference Japanese Patent Application No. 2007-49558 filed on Feb. 28, 2007.

### FIELD OF THE INVENTION

The presented invention relates to an electronic key system, in which an in-vehicle unit mounted in a vehicle and a portable unit carried by a user of the vehicle execute radio communication for authentication of a user carrying the portable unit by the in-vehicle unit.

### BACKGROUND OF THE INVENTION

In the field of vehicle-related technology, an electronic key system is constructed with an in-vehicle unit mounted in a vehicle and a portable unit carried by a user of the vehicle. In this type of electronic key system, the following is implemented without mechanical key operation: door lock/unlock operation, engine starting operation, and the like are controlled as long as authentication has been successfully completed between the in-vehicle unit and the portable unit by radio communication. This greatly contributes to the user's convenience.

In recent years, large-scale commercial facilities, such as large-scale malls, theme parks, ski resorts, and airports, usually have larger parking lots than ever. It has been increasingly difficult for users to promptly find their own vehicles there.

Even though a user roughly grasps the location of his/her vehicle, it is difficult for him/her to pinpoint the precise location of the vehicle. This is because the parking lot is so large that the surrounding scenery (the location of a landmark, etc.) remains unchanged even though he/she takes a little walk in the lot or his/her own vehicle is blended into a lot of vehicles. Especially, not a few visitors to such large-scale commercial facilities visit there for the first time or for the second or third time at most. Such persons are unfamiliar with the surrounding environments and it is even more difficult for them to find their vehicles there.

When a vehicle is covered with snow at a ski resort or the like, a user of the vehicle will have difficulty in finding the vehicle. Furthermore, some users do not have the will to keep the locations of their vehicles in mind from the beginning, and they do not get even a clue to the approximate locations of their vehicles.

To cope with this, JP 2003-319441 proposes a searching device for making it possible to easily grasp the location of a vehicle. This vehicle searching device is constructed with a transmitter/receiver unit mounted in a vehicle and a mobile terminal carried by a user, and has the following functions (A) and (B):

(A) When the user operates the mobile terminal, the mobile terminal communicates with the transmitter/receiver unit and receives information on the location of the vehicle from the transmitter/receiver unit. This location information indicates the direction of the vehicle relative to the presented location of the user (location of the mobile terminal) and the distance between them. The mobile terminal displays the received location information.

(B) Both the mobile terminal and the transmitter/receiver unit have the GPS functions. Each of them computes the presented position of it and transmits it to a server. The mobile terminal receives the presented position of the mobile terminal and the presented position of the transmitter/receiver unit (vehicle) from the server, and displays them at a time.

Even though the above vehicle searching device is used, however, the user may not grasp even the approximate location of the vehicle and he/she is at some distance from the vehicle. When radio communication is not established between the mobile terminal and the transmitter/receiver unit, the mobile terminal or the transmitter/receiver unit cannot execute radio communication with each other. The function (A) above becomes unavailable, and the user cannot pinpoint the location of the vehicle.

As an example, it will be assumed that there are parking lots on all four sides of a facility (building) and the user gets the erroneous idea about the location of his/her vehicle. He/she is not at a parking lot where he/she parked his/her vehicle but at a parking lot on the opposite side of the building. In this case, it is guessed that the function (A) above will not work.

According to the function (B) above, a user can pinpoint the location of his/her vehicle even though radio communication is not established between the mobile terminal and the transmitter/receiver unit. In this case, however, the GPS function and a server are required, and this complicates and upsizes the mobile terminal and the transmitter/receiver unit.

When the mobile terminal of the vehicle searching device is increased in size, many people will feel it burdensome to carry the large mobile terminal or may not want to carry it.

A problem common to the functions (A) and (B) is that the location of the mobile terminal itself need be pinpointed. Consequently, a construction for making it possible to pinpoint the location of the mobile terminal itself is required, and this incurs the above problem of upsizing and complication.

### SUMMARY OF THE INVENTION

It is an object of the invention to make it possible to remind a user of the location of his/her vehicle without fail through a simpler construction in an electronic key system for vehicles and thus for the user to pinpoint the location of his/her vehicle.

According to one aspect of the invention, an electronic key system includes an in-vehicle unit mounted in a vehicle and a portable unit carried by a user execute radio communication with each other for authentication. The in-vehicle unit includes a position information transmitting circuit capable of transmitting information on the relative position between the vehicle and a landmark object near the vehicle. The portable unit, when relative position information is transmitted from the in-vehicle unit, receives this relative position information, and notifies nearby people of the relative position between the vehicle and the landmark object, representeded by the relative position information.

Any object, including a building or an intersection near the vehicle, can be a landmark object as long as its location is unchanged. A landmark object may be acquired from, for example, predetermined map information or the like or may be acquired from the data of an image picked up outside the vehicle (image data) or the like. Any section may be adopted as a notifying device as long as it can notify the user of a relative position so that he/she can recognize it. For example, such a device that the user can recognize the relative position by at least any of acoustic sense, visual sense, touch sense, and the like can be adopted. Further, such a device that the user can recognize by gustatory sense or olfactory sense can also be adopted.

In the electronic key system, preferably, information on the relative position between the vehicle and a landmark object is notified at the portable unit. If only the user can grasp the location of a landmark object, therefore, he/she can recall or pinpoint the location of the vehicle from the location of the landmark object. With the electronic key system, the user can manage to arrive at his/her vehicle from where he/she is without computing the location of the portable unit itself. (That is, the user can manage to arrive at his/her vehicle even when the user does not know his/her presented position.)

It is thus unnecessary to provide a construction for computing the location of the portable unit. This makes it possible to simplify the construction of the in-vehicle unit and the portable unit and thus the entire system, and the user can recall (pinpoint) the location of his/her vehicle with reliability and ease.

### BRIEF DESCRIPTION OF THE DRAWINGS

The above and other objects, features and advantages of the presented invention will become more apparent from the following detailed description made with reference to the accompanying drawings. In the drawings:

FIG. 1 is a block diagram of an electronic key system in a first embodiment of the presented invention;

FIGS. 2A, 2B and 2C are flowcharts of processing executed by an in-vehicle unit, a portable unit and the portable unit, respectively;

FIG. 3 is a flowchart of processing executed by a vehicle navigation device;

FIGS. 4A, 4B and 4C illustrate examples of images (illustrations) displayed on a display of the portable unit, respectively;

FIGS. 5A and 5B illustrate examples of texts displayed on the display of the portable unit, respectively;

FIG. 6 is a block diagram of an electronic key system in a second embodiment of the presented invention;

FIG. 7 is a block diagram of an electronic key system in a third embodiment of the presented invention;

FIGS. 8A and 8B are flowcharts of processing executed by an in-vehicle unit and a portable unit in third embodiment, respectively; and

FIGS. 9A and 9B are block diagrams of an electronic key system in a fourth embodiment of the presented invention.

### DETAILED DESCRIPTION OF THE PREFERRED EMBODIMENTS

### First Embodiment

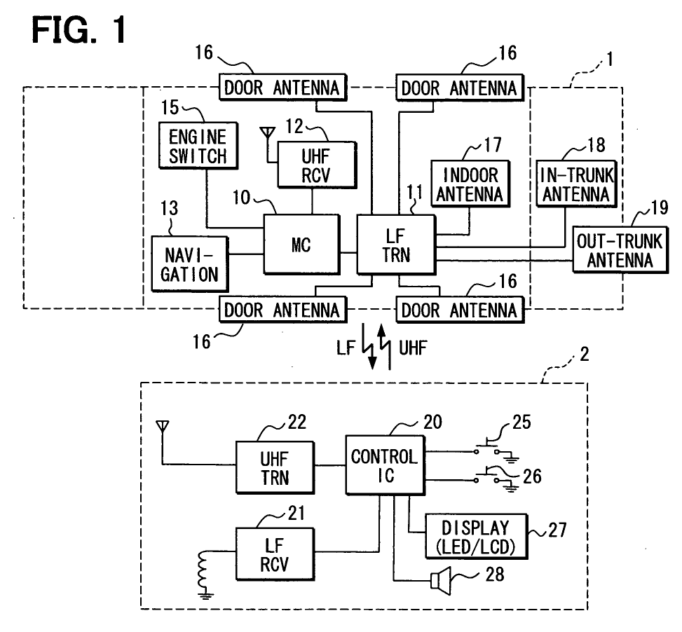

Referring first to FIG. 1, an electronic key system is constructed with an in-vehicle unit 1 mounted in a vehicle and a portable unit 2 carried by a user. The system has the following functions: a smart entry function of controlling door unlock operation or the like automatically when the portable unit 2 enters a radio communication area around the vehicle; and a remote keylestransmittedry function of controlling door lock/unlock operation or the like according to manual button operation on the portable unit.

Specifically, the in-vehicle unit 1 includes: a microcomputer 10, a low frequency (LF) transmitter unit 11, an ultra-high frequency (UHF) receiver unit 12, a vehicle navigation device 13, an engine switch 15, door antennas 16, an indoor antenna 17, an in-trunk antenna 18, an out-trunk antenna 19, and the like.

The LF transmitter unit 11 is used to transmit radio signals to the portable unit 2 by radio waves in the LF band. Radio signals transmitted from the LF transmitter unit 11 reach the portable unit only in the respective limited communication areas through the door antennas 16 located in four places, indoor antenna 17, in-trunk antenna 18, and out-trunk antenna 19. The UHF receiver unit 12 is used to receive radio signals transmitted from the portable unit 2 by radio waves in the UHF band.

The vehicle navigation device 13 computes the presented position of the vehicle, the traveling direction of the vehicle, the distance to an objective point, and the like utilizing a well-known GPS.

The vehicle navigation device 13 generates information indicating the presented position of the vehicle. This is information indicates the relative position between the vehicle and a landmark object, as described later. This information is referred to as relative position information. At the same time, a signal indicating this relative position information is transmitted from the LF transmitter unit 11. The nearest building from the vehicle is automatically set as a landmark object.

The engine switch 15 is operable by the user to start the engine. When it is detected through a signal from the engine switch 15 that the user has operated the engine switch 15, the microcomputer 10 checks whether an engine start may be permitted. When an engine start may be permitted, an engine start signal is transmitted from the microcomputer 10 to an engine control system (not shown).

The portable unit 2 includes a control IC 20, an LF receiver unit 21, a UHF transmitter unit 22, push switches 25, 26, a display 27, a speaker 28, and the like.

The LF receiver unit 21 is used to receive radio signals transmitted from the in-vehicle unit 1 by radio waves in the LF band. The UHF transmitter unit 22 is used to transmit radio signals to the in-vehicle unit 1 by radio waves in the UHF band.

The push switches 25, 26 are provided as keys that function as triggers mainly for the remote keylestransmittedry function. When one push operation is performed on the push switch 25, the doors are locked. When it is performed on the push switch 26, the doors are unlocked.

The display 27 is an LED or an LCD screen. It functions as a notifying device for the notification of the location of the vehicle. To visually notify of the location of the in-vehicle unit 1 (that is, location of the vehicle), it displays an image on the LCD screen or blinks the LED. The speaker 28 also functions as a notifying device for notifying of the location of the vehicle by sound.

Each component of the in-vehicle unit 1 is controlled and operated by the microcomputer 10, and the LF transmitter unit 11 periodically transmits a transmission request signal under the control of the microcomputer 10. Each component of the portable unit 2 is controlled and operated by the control IC 20. When the portable unit 2 enters the radio communication area where it can receive the transmission request signal from the LF transmitter unit 11, this transmission request signal is received by the LF receiver unit 21.

Signal transmission utilizing radio waves in the LF band is executed between the LF transmitter unit 11 and the LF receiver unit 21. The purpose of this is to limit the communication area between the in-vehicle unit 1 and the portable unit 2 to the vicinity of the vehicle. Especially, by transmitting signals from the door antennas 16, indoor antenna 17, in-trunk antenna 18, out-trunk antenna 19, or the like, the communication area can be limited to the following: the vicinity of the doors, the interior of the vehicle compartment, the interior of the trunk, and the exterior of the trunk. This makes it possible to reduce the possibility that the portable unit 2 receives, for example, a transmission request signal from in-vehicle units of other vehicles.

When the LF receiver unit 21 receives the transmission request signal from the in-vehicle unit 1, the UHF transmitter unit 22 transmits an acknowledgement signal in the UHF band as a response signal containing a code specific to the vehicle corresponding to the portable unit 2. In the in-vehicle unit 1, the UHF receiver unit 12 receives the acknowledgement signal from the portable unit 2.

Signal transmission utilizing radio waves in the UHF band is executed between the UHF transmitter unit 22 and the UHF receiver unit 12. The reason for this is as follows: even though the output level of the portable unit 2 is relatively weak, a certain communication distance can be ensured and acknowledgement signals can be more reliably communicated to the in-vehicle unit 1.

When the UHF receiver unit 12 receives the acknowledgement signal from the portable unit 2, the microcomputer 10 of the in-vehicle unit 1 executes authentication operation. That is, it checks whether the code contained in the acknowledgement signal agrees with the code stored in the microcomputer 10. When the codes agree with each other, door unlock operation is permitted.

At the subsequent S, well-known control with respect to this type of electronic key systems is executed. For example, the above unlock operation has been permitted and it is detected through a signal from a touch sensor (not shown) provided in the outside door handle of the driver's seat door that someone has touched the door handle. Thus, the microcomputer 10 transmits an unlock signal to a door control system. As a result, a door lock motor (not shown) is driven to unlock all the doors. In addition, various controls, such as permission of an engine start, are executed. Since these controls do not have a direct relation with the subject matter of the invention, however, the further description will be omitted.

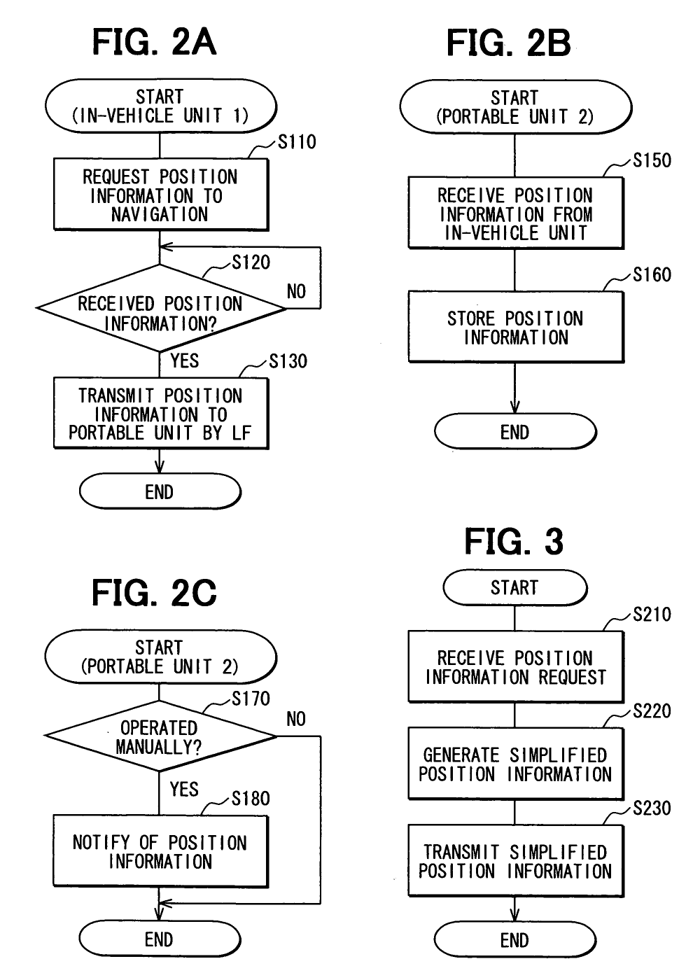

Information on the relative position of the vehicle is transmitted from the in-vehicle unit 1 to the portable unit 2 as shown by flowcharts in FIGS. 2A to 2C and FIG. 3.

First, the processing of relative position information transmission is executed by the in-vehicle unit 1 as shown in FIG. 2A. This processing of relative position information transmission is specifically executed by the microcomputer 10. The processing is started on the following occasions: when the user gets out of the vehicle; when the user moves away from the vehicle; or when it is determined that the user will highly probably get out of or move away from the vehicle. The microcomputer 10 of the in-vehicle unit 1 also checks whether some occasion corresponds to any of these occasions.

Examples of these occasions are: when the engine switch 15 is turned off; when the vehicle stops, when the shift position of the vehicle changes to the parking position; when a parking brake is applied; when a vehicle door is opened; when a vehicle door is opened (the user gets out of the vehicle) and then the door is closed; when a door is closed and locked; and the like. In addition, the following occasions may be included: when the engine switch 15 is turned off, when the transmission shift position changes to the parking potion, a vehicle door is opened after the parking brake is applied a vehicle door is opened, or a door is opened (the user gets out of the vehicle) and then closed; when the door is closed and then locked; and the like.

The processing of relative position information transmission illustrated in FIG. 2A is executed as described below. When the engine switch 15 of the vehicle is turned off to leave the vehicle, for example, the microcomputer 10 outputs a request for information on the relative position of the vehicle to the vehicle navigation device 13 at S110. The vehicle navigation device 13 generates relative position information at S220 in FIG. 3, described later, and outputs this relative position information to the microcomputer 10 at S230.

The microcomputer 10 then executes S120 to determine whether the relative position information has been received from the vehicle navigation device 13. When the microcomputer 10 determines that the information has been received (S120: YES), it proceeds to S130. When the microcomputer 10 determines at S120 that the relative position information has not been received, it repeats the processing of S120 (wait for reception).

At S130, the microcomputer 10 transmits the relative position information received from the vehicle navigation device 13 to the portable unit 2 through the LF transmitter unit 11. Thereafter, it terminates this series of processing. At S130, a signal indicating the relative position information is transmitted.

On the several occasions listed above, the user is in the vicinity of the vehicle substantially without doubt; therefore, the portable unit 2 will surely receive the relative position information. Even though the user does not have a will to keep the location of the vehicle in mind when he/she gets out of or leaves the vehicle, for example, information on the relative position of the vehicle is transmitted to the portable unit 2.

In the portable unit 2, the processing of FIGS. 2B and 2C are executed by the control IC 20.

The portable unit 2 waits for the relative position information from the in-vehicle unit 1. At S150, it receives the relative position information from the in-vehicle unit 1. The control IC 20 stores at S160 the received relative position information in a memory (not shown) in the portable unit 2. Thereafter, the control IC 20 terminates this series of processing.

The processing of relative position information notification illustrated in FIG. 2C is periodically executed. At S170, the portable unit 2 checks whether a predetermined switch of the portable unit 2 has been operated by the user. This switch may be used to cause the portable unit 2 to notify of relative position information. When the control IC 20 determines at S170 that the predetermined switch has not been operated (S170: NO), it immediately terminates this series of processing.

When the control IC determines at S170 that the predetermined switch has been operated (S170: YES), it executes S180 and reads the relative position information stored in the memory at S160 and notifies nearby people of the information. Thereafter, the control IC 20 terminates this series of processing. Possible methods for the notification include: displaying an image on the LCD screen of the display 27; blinking the LED; emitting a sound from the speaker 28; vibrating the portable unit 2; and the like.

The vehicle navigation device 13 executes the processing shown in FIG. 3.

The vehicle navigation device 13 waits for the request for the relative position information outputted from the microcomputer 10. When the request for relative position information is outputted from the microcomputer 10 at S110, the vehicle navigation device 13 receives this request for relative position information at S210. When the request for relative position information is outputted when the engine switch 15 is turned off, for example, the vehicle navigation device 13 has been brought into a sleep state by the turn-off of the engine switch 15. In this sleep state a minimum function requiring for monitoring a predetermined start signal is only working. For this purpose, the vehicle navigation device 13 is configured to be able to monitor the request for relative position information in the sleep state. Thus, the vehicle navigation device 13 is activated when the request for relative position information is received. When the request for relative position information is received, however, a minimum function required for generating relative position information is only started.

The vehicle navigation device executes S220 and generates information on the relative position of the vehicle.

It is well known that commonly used vehicle navigation devices compute the presented position of the subject vehicle and displays the presented position on a liquid crystal display, for example, together with a map or notifies nearby people of it by voice. The vehicle navigation device 13 computes the presented position of the vehicle as in conventional cases. However, it is not realistic to transmit a large volume of data (e.g., data containing a detailed map, color data, etc.) to the portable unit 2 by a conventional technique. This is because it takes a long time for communication to be completed. Another reason is that a very large memory is required in the portable unit 2 and the portable unit 2 cannot be reduced in size.

To cope with this, at S220, the vehicle navigation device 13 generates the relative position information small in data amount as simplified relative position information to be transmitted to the portable unit 2.

After S220, the vehicle navigation device proceeds to S230 and outputs the simplified relative position information generated at S220 to the microcomputer 10. Thereafter, it terminates this series of processing.

The simplified relative position information generated at S220 may be formed in the following manner. The simplified relative position information may include image data, text data, and the like. Text data indicates only characters (including symbols, signs, and the like) without regard to data format. The image data may include data indicating an illustration (graphic) and character image data.

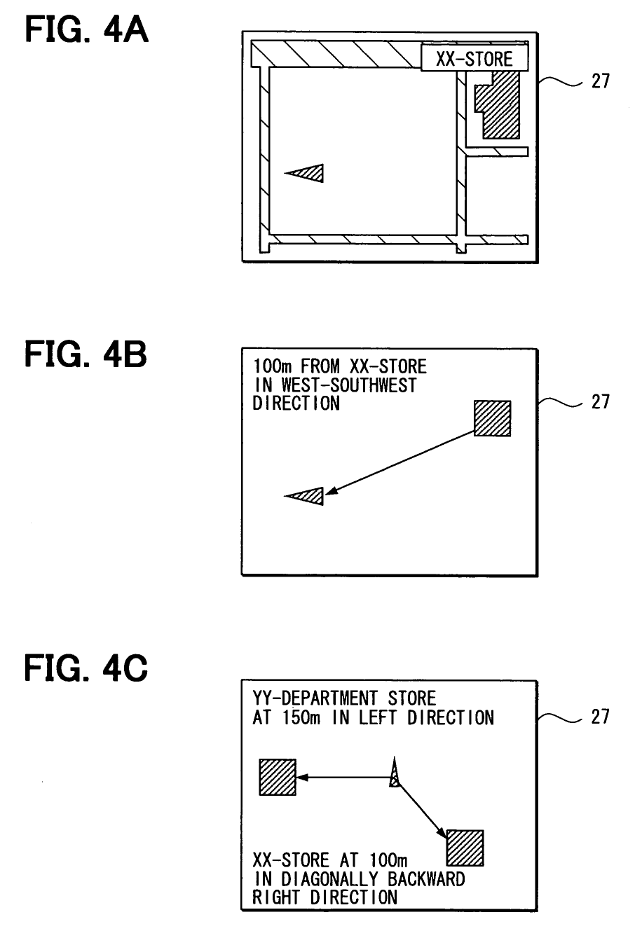

In the first embodiment, image data is adopted and some screen image examples are shown in FIGS. 4A to 4C. One of advantages obtained when the image data is used is that the user can visually recognize the location of the vehicle with ease.

For this image display, the data amount of image data is reduced by techniques listed below as examples. These techniques are just examples, and any technique can be used.
(1) Monochrome images are used;
(2) Images are compressed (pixel data is thinned out);
(3) Illustrations representing buildings are simplified (represented as rectangles);
(4) Illustrations of buildings are only used (the names, etc. are omitted);
(5) Only names of buildings are used (the graphics of buildings are omitted);
(6) Only positional relation is illustrated (road maps, etc. are omitted);
(7) The illustration of the vehicle is omitted. In this case, for example, a rule that the center of an image should be taken as the presented position of the vehicle is prescribed beforehand. Thus, the user can grasp the relative position between the vehicle and a landmark object without an image of the vehicle.

FIG. 4A illustrates an example in which the illustrations of the vehicle (triangle) and a landmark object are displayed together with a map. For example, the techniques (1) and (2) above are applied. When a road map is displayed as illustrated in FIG. 4A, the user can recall and thus pinpoint the location of the vehicle without detailed display of the direction of the vehicle relative to the landmark object or the distance between them. In the example of FIG. 4A, the shape of the building may be simply representeded as a rectangle (the technique (3) above is applied). Or, the character data of “XX-Store” may be omitted (the technique (4) above is applied).

FIG. 4B illustrates an example in which the illustration of a building is simplified (the technique (3) above is applied), and a map is omitted (the technique (6) above is applied). In this case, it is desirable to display, for example, the direction of the vehicle relative to the landmark object and the distance between them.

FIG. 4C illustrates an example in which the technique (6) above is applied as in the example illustrated in FIG. 4B. In this case, especially, the direction of the landmark object and the distance to it are displayed with the vehicle at the center. The direction is representeded with the front part of the vehicle taken as “forward.” When the user parks his/her vehicle in a parking lot, he/she grasps the surrounding situation with the vehicle at the nucleus. In the case illustrated in FIG. 4C, therefore, the user can easily recall or pinpoint the location of the vehicle. In this example, two facilities, XX-Store and YY-Department Store, are set as landmark objects. For this reason, the user can more easily recall or pinpoint the location of the vehicle.

According to the first embodiment, the following processing is executed when the user gets out of or leaves the vehicle or there is a high possibility that he/she will get out of or leave the vehicle. The in-vehicle unit 1 generates the relative position information indicating the relative position between the vehicle and the landmark object near the vehicle. This relative position information is transmitted to the portable unit 2 carried by the user. For this reason, even when the user inadvertently forgets the location of the vehicle when he/she gets out of or leaves the vehicle or when he/she forgets the once memorized location, the user can easily recall the location of the vehicle and arrive at the vehicle without difficulty by referring to the relative position information displayed on the portable unit 2.

Especially, the information on the relative position between the vehicle and the landmark object is generated, and the location of the portable unit 2 need not be known. Therefore, it is unnecessary to provide a construction for computing the location of the portable unit 2. This makes it possible to prevent the size of the in-vehicle unit 1 or the portable unit 2 from being increased. That is, the portable unit 2 can be reduced in size, and this enhances user-friendliness.

Since the relative position information is graphically displayed, the user can visually recognize the location of the vehicle with ease and easily understand the location of the vehicle.

In the first embodiment, the processing of S130 corresponds to a section; the processing of S150 corresponds to a position information receiving section; the processing of S180, the display 27, and the speaker 28 correspond to notifying section; the display 27, especially, its LCD screen corresponds to a displaying section; and the microcomputer 10 corresponds to a transmission timing determining section.

### First Modification

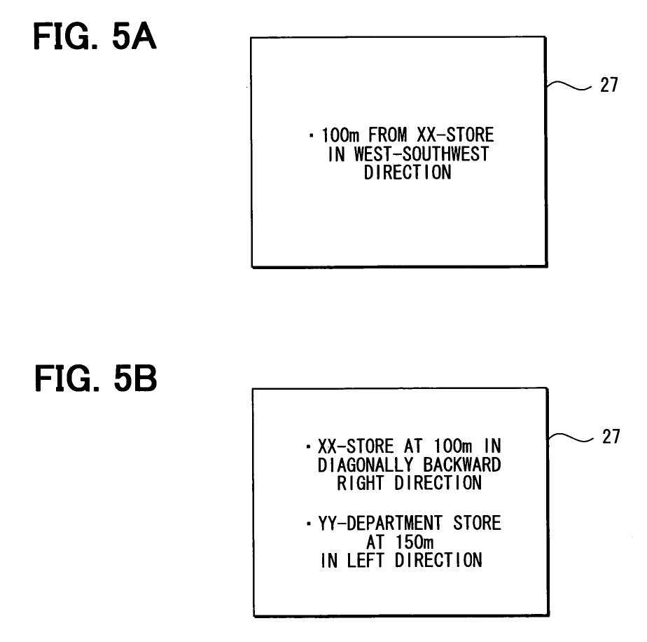

FIGS. 5A and 5B illustrate examples of screen images displayed on the display 27 when text data is adopted. One of advantages obtained when the text data is used is that a data amount can be reduced as compared with image data.

When text data is used, the direction and the distance indicating the positional relation between the vehicle and a landmark object only have to be known. A possible example is “100 m west-southwest of landmark object” (Example 1).

In case of text data, information contains only characters. Therefore, it is desirable to display the name of a landmark object. When multiple landmark objects are set, a name is required for each landmark object.

Consequently, it is desirable to include the name of a landmark object as illustrated in FIG. 5A. That is, text data of “100 m from XX-store in west-southwest direction” (Example 2) is generated. When multiple landmark objects are set, for example, text data of “150 m from YY Department Store in north direction” (Example 3) can be added to Example 2.

Further, the text data may indicate the direction of and the distance to a landmark object relative to the vehicle with the front part of the vehicle taken as “forward,” as mentioned above.

A possible example of text data is “landmark object 100 m in diagonally backward right direction” (Example 4). When the name of the building is added to Example 4, text data of “XX-Store at 100 m in diagonally backward right direction” (Example 5) is obtained. When multiple landmark objects are presented, text data of “YY-Department Store at 150 m in left direction” (Example 6) can be added to Example 5. FIG. 5B illustrates an example in which text data of Example 5 and that of Example 6 are displayed.

Even when only text data is displayed, the user will be able to relatively easily grasp a landmark object. When the user is familiar with the environment in the vicinity of a parking lot, for example, the user can easily grasp the location of a landmark object. Even when the user is not familiar with the surrounding area, he/she will be able to find a desired building from a billboard, its appearance (to be specific, service mark and corporate color), or the like without difficulty. Consequently, it is supposed that the user can sufficiently recall the location of his/her vehicle with text data only.

According to the first modification, an amount of data transmitted from the in-vehicle unit 1 to the portable unit 2 can be reduced. It is thus unnecessary to provide the portable unit 2 with a very large memory, for example. Transmission and reception of data are quickly completed, and thus it is possible to ensure that data is reliably transmitted and received.

### Second Modification

In the second modification, the portable unit 2 notifies of the relative position information by sound, light, and vibration as well.

For example, the LED provided in the display 27 is turned on and the pattern of its blinking may be varied. A sound may be emitted from the speaker 28, or the entire portable unit 2 may be vibrated by a vibrating mechanism (not shown), and the pattern of its vibration may be varied. The mobile device notifies of a direction indicating the relative position between the vehicle and a landmark object and the distance between them by these section.

Examples of this sound include a sound like human voice (speech sound) and a melody. A detailed example of speech sound is reading aloud such text data as mentioned above. An example of melody is representeding a direction or a distance by a melody pattern.

In examples of light and vibration, north, south, east or west is notified by taking, for example, the following measures: one time of 0.5-second lightup and vibration indicates north; two times of 0.5-second lightup and vibration indicate south; one time of one-second lightup and vibration indicates east; and two times of one-second lightup and vibration indicate west. Though not especially described as an example, distances can also be similarly notified. To indicate all the detailed directions and distances, a large number of patterns of lightup and vibration are required. For this reason, only approximate directions and distances may be notified to reduce the number of types of patterns of lightup and vibration. Further, lighting and vibrating operation may be performed in accordance with the rules of the Morse code, for example.

According to the second modification, the user can grasp relative position information without taking the trouble to take out the portable unit 2 and refer to the display 27 (LCD screen). For example, the user can put the portable unit 2 in his/her jacket or pants pocket. Thus, he/she can hear a sound (speech sound) from the portable unit 2 or feel a vibration pattern even when both his/her hands are filled with luggage. He/she can thereby recognize relative position information and easily recall the location of the vehicle. This dramatically enhances the user's convenience.

Even when it is dark and the user cannot view an image displayed on the LCD screen, he/she can recognize relative position information by sound (speech sound) or lighting and vibration patterns and recall the location of the vehicle. This prevents the user from being disabled finding his/her vehicle in the darkness. For this reason, it is possible to dare not provide a backlight for the LCD screen to suppress increase in the cost or size of the portable unit 2.

### Second Embodiment

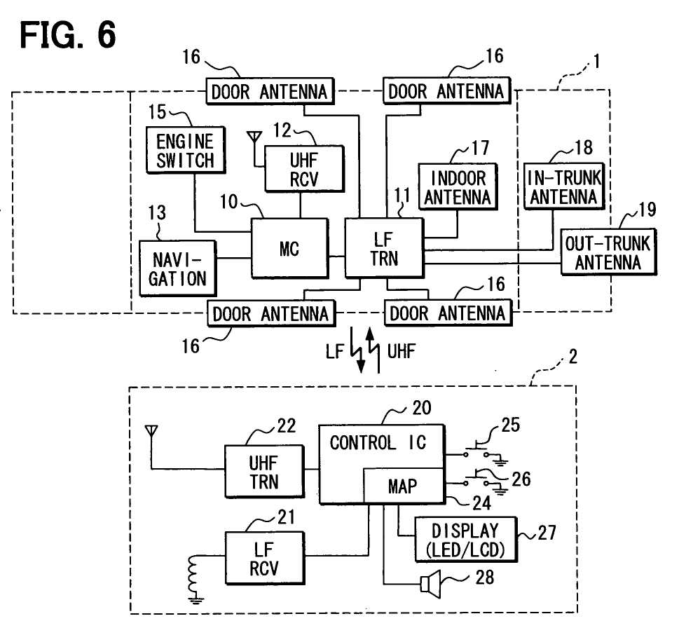

The electronic key system in the second embodiment shown in FIG. 6 is different from the electronic key system in the first embodiment in that the control IC 20 has a map generation unit 24. The map generation unit 24 is used to generate maps (illustrations) indicating the location of the vehicle from relative position information received by the LF receiver unit 21.

The portable unit 2 includes the map generation unit 24. Therefore, when the system is so constructed that, for example, it is only necessary that the text data is transmitted from the in-vehicle unit 1 to the portable unit 2. This is because the map generation unit 24 can generate maps (images) from text data. For this reason, the second embodiment adopts text data.

Specifically, the map generation unit 24 generates the map (image) illustrated in FIG. 4C from the text data illustrated in FIG. 5B. That is, the map generation unit 24 recognizes the relative positional relation between the vehicle and a landmark object from text data, and generates an illustration representeding this relative positional relation.

According to the second embodiment, an illustration can be displayed on the portable unit 2 just by transmitting, for example, text data from the in-vehicle unit 1 to the portable unit 2. Therefore, it is possible to shorten time of communication between the in-vehicle unit 1 and the portable unit 2 and suppress an increase in the memory capacity of the portable unit 2. At the same time, illustrations are displayed on the portable unit 2 to enhance the user's convenience.

In the second embodiment, a construction including the map generation unit 24 to the construction of the notifying section in the first embodiment corresponds to the notifying section.

### Third Embodiment

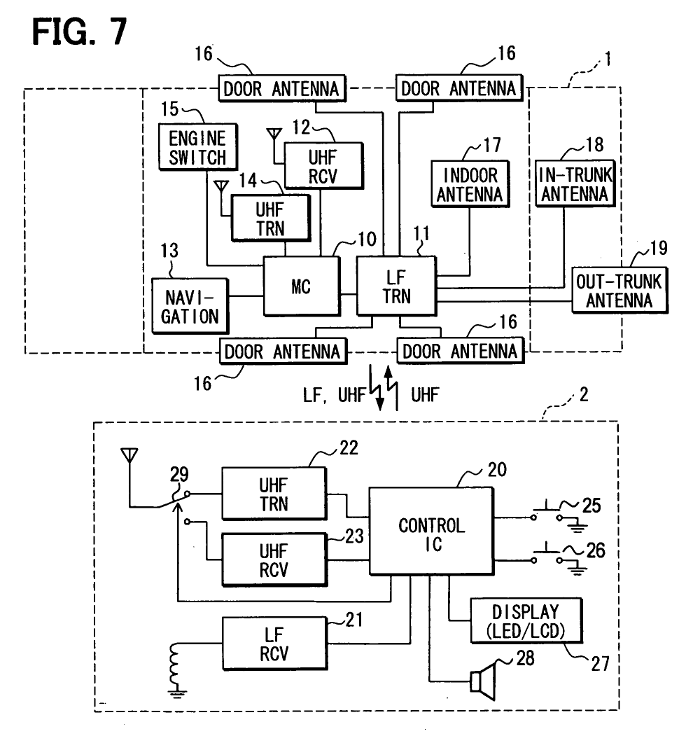

The electronic key system in the third embodiment shown in FIG. 7 is different from the electronic key system in the first embodiment in that: the in-vehicle unit 1 has a UHF transmitter unit 14; and the portable unit 2 has a UHF receiver unit 23 and a transmission/reception selector switch 29.

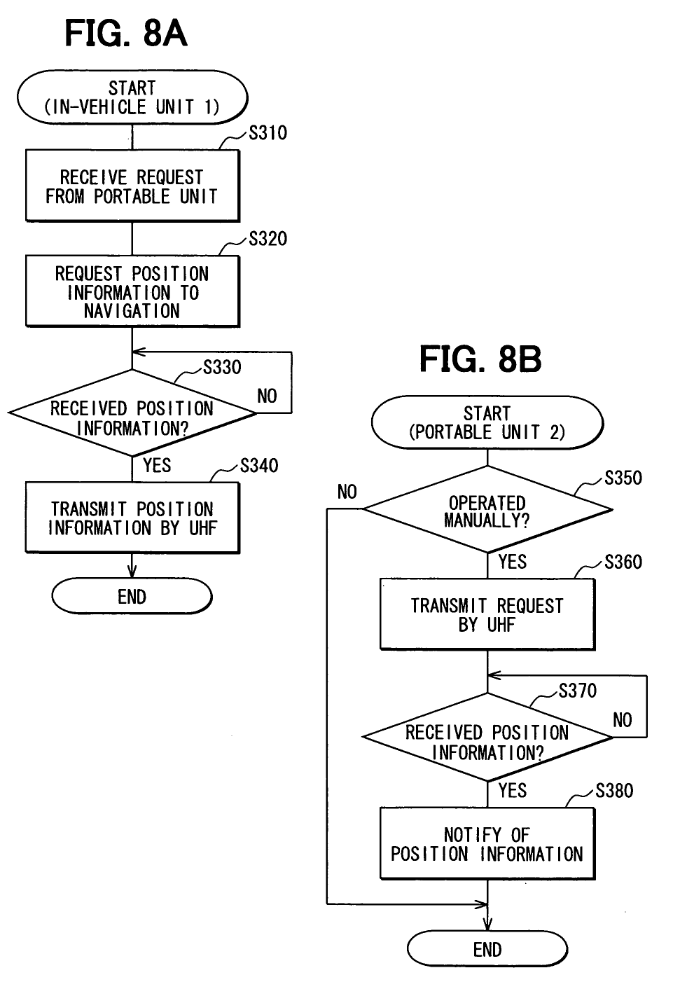

In addition, the electronic key system is different from the electronic key system in the first embodiment in that: the in-vehicle unit 1 executes the processing illustrated in FIG. 8A in addition to the processing in FIG. 2A; and the portable unit 2 executes the processing illustrated in FIG. 8B in addition to the processing in FIGS. 2B and 2C.

The UHF transmitter unit 14 is not a substitution for the LF transmitter unit 11. Either the LF transmitter unit 11 or the UHF transmitter unit 14 functions to transmit relative position information to the portable unit 2.

The UHF receiver unit 23 is provided for receiving relative position information transmitted from the in-vehicle unit 1 by radio waves in the UHF band. The relative position information is transmitted from either the LF transmitter unit 11 or the UHF transmitter unit 14. On the part of the portable unit 2, therefore, both the LF receiver unit 21 and the UHF receiver unit 23 function to receive the relative position information.

Switching of the transmission/reception selector switch 29 is controlled by the control IC 20. Whether to execute transmission by the UHF transmitter unit 22 or reception by the UHF receiver unit 23 can be changed by this selector switch 29.

The in-vehicle unit 1, specifically the microcomputer 10, executes processing of request information reception shown in FIG. 8A. The in-vehicle unit 1 waits for a request for relative position information transmitted from the portable unit 2 (S360 in FIG. 8B). When the request for relative position information is transmitted from the portable unit 2, the in-vehicle unit 1 receives this request for relative position information, transmitted from the portable unit 2, at S310. This request for relative position information may be transmitted by the user operating a predetermined switch (switch for causing a request to be transmitted) of the portable unit 2.

The microcomputer 10 executes S320, and transmits a request for relative position information to the vehicle navigation device 13. The vehicle navigation device 13 executes the same processing as in FIG. 3. That is, the relative position information is generated at the vehicle navigation device 13 (S220) and is transmitted to the microcomputer 10 (S230).

After the processing of S320, the microcomputer 10 executes S330, and checks whether the relative position information has been received from the vehicle navigation device 13. When the microcomputer 10 determines that the information has been received (S330: YES), it executes S340. When the microcomputer 10 determines at S330 that the relative position information has not been received from the vehicle navigation device 13 (S330: NO), it repeats the processing of S330 (wait for reception).

At S340, the microcomputer 10 transmits the relative position information to the portable unit 2. At this time, it transmits the information through the UHF transmitter unit 14, that is, utilizing radio waves in the UHF band. The reason for this is as follows: time when the request for relative position information is transmitted from the portable unit 2 is when the user operates the portable unit 2; and in this case, there is a high possibility that the portable unit 2 is at a point distant from the vehicle. To establish communication without fail, consequently, radio waves in the UHF band are utilized. After the processing of S340, the microcomputer 10 terminates this series of processing.

In the portable unit 2, the control IC 20 executes the processing of request information transmission as shown in FIG. 8B. At S350, the portable unit 2 checks whether a predetermined switch (switch for causing a request to be transmitted) has been operated by the user. When the control IC 20 determines that the switch has not been operated (S350: NO), it immediately terminates this series of processing. When the control IC determines at S350 that the predetermined switch has been operated, it executes S360 and transmits a request for relative position information.

Thereafter, it executes S370 to checks whether the relative position information has been received from the in-vehicle unit 1. When the control IC 20 determines that the information has not been received (S370: NO), it repeats the processing of S370 (wait for reception).

When the control IC 20 determines at S370 that relative position information has been received (S370: YES), it executes S380 and notifies nearby people of the relative position information. Thereafter, it terminates this series of processing.

In the third embodiment, that is, relative position information is notified in two patterns.

The first pattern is used when the relative position information is not requested by the portable unit 2 but the relative position information is automatically transmitted from the in-vehicle unit 1 to the portable unit 2. An example of this case is, as described also in the first embodiment, when the user gets out of or leaves the vehicle. The portable unit 2 once stores this relative position information in its memory. Thereafter, it reads the stored relative position information according to the user's operation and notifies nearby people of it.

The second pattern is used when the request is transmitted from the portable unit 2 to the in-vehicle unit 1 and, as a result, the portable unit 2 receives the relative position information from the in-vehicle unit 1. An example of this case is when the user looks for the vehicle. In this case, the received relative position information is not stored in the memory but is swiftly notified.

Also in the third embodiment, the following operation is performed as in the first pattern mentioned above: when the user leaves the vehicle, for example, the relative position information is automatically transmitted from the in-vehicle unit 1 to the portable unit 2. Therefore, it may be thought that it is unnecessary for the user to take the trouble to operate the portable unit 2 to request the relative position information from the in-vehicle unit 1 as in the second pattern.

However, there are cases where a family member, a friend, or the like in possession of a spare key uses the vehicle. In some parking lots, an attendant may appropriately change the location of the vehicle. That is, there are possible cases where the user parks his/her vehicle and the location of the vehicle is thereafter changed.

To cope with this, the electronic key system is so constructed as in the third embodiment. That is, it is so constructed that the relative position information is transmitted from the in-vehicle unit 1 to the portable unit 2 according to the request from the user (request from the portable unit 2). Thus, even though the location of the vehicle is changed, the user can grasp the location of the vehicle without trouble.

In the third embodiment, the in-vehicle unit 1 includes the UHF transmitter unit 14. The UHF transmitter unit 14 can be easily added to the existing construction of the in-vehicle unit 1, and it is unnecessary to change the construction or wiring of the in-vehicle unit 1.

In the third embodiment, the processing of S310 corresponds to a request information receiving section; the processing of S360 corresponds to a request information transmitting section; the LF transmitter unit 11 corresponds to a first in-vehicle unit side communicating section; the UHF receiver unit 12 and the UHF transmitter unit 14 correspond to second in-vehicle unit side communicating section; the LF receiver unit 21 corresponds to a first portable unit side communicating section; and the UHF transmitter unit 22 and the UHF receiver unit 23 correspond to second portable unit side communicating section.

### Fourth Embodiment

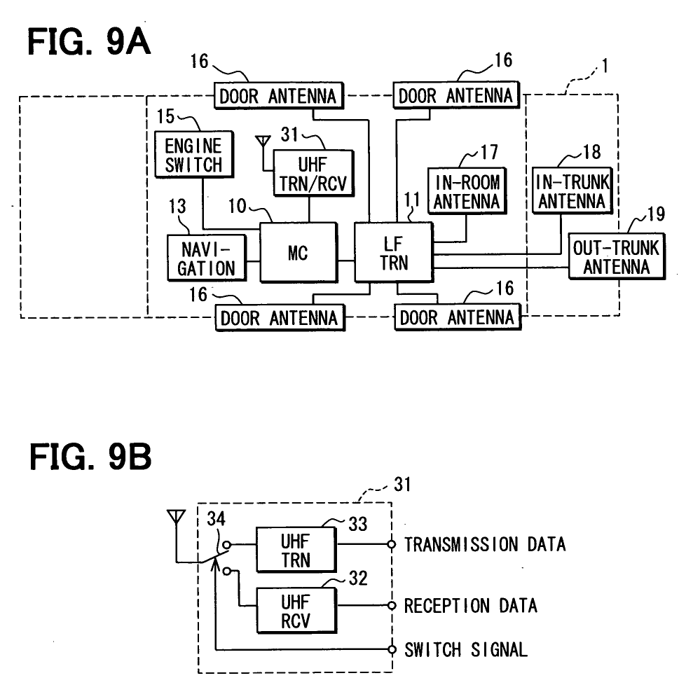

The electronic key system is constructed as shown in FIGS. 9A and 9B in the fourth embodiment, which is a partial modification of the third embodiment. Specifically, the electronic key system is provided with a UHF transmitter/receiver unit 31 in place of the UHF receiver unit 12 and the UHF transmitter unit 14. This UHF transmitter/receiver unit 31 has a UHF receiver unit 32 and a UHF transmitter unit 33 in it. Whether to execute reception by the UHF receiver unit 32 or to execute transmission by the UHF transmitter unit 33 can be changed by a transmission/reception selector switch 34.

This construction of the UHF transmitter/receiver unit 31 makes it possible to use a single antenna both when radio waves in the UHF band are transmitted and when they are received. When the UHF receiver unit 32 and the UHF transmitter unit 33 are integrated with each other, increase in the size of the unit (UHF transmitter/receiver unit 31) can be suppressed. Thus, increase in the size of the entire in-vehicle unit 1 can be suppressed.

In the fourth embodiment, the UHF transmitter/receiver unit 31 corresponds to a second in-vehicle unit side communicating section.

The invention is not limited to the above embodiments, and it can be variously embodied without departing from the technical scope of the invention.

In the above embodiments, the nearest one from the vehicle of buildings near the vehicle is automatically selected as a landmark object. At this time, there is no limitation on a selection criterion. For example, the largest building (building having the largest site area) may be selected as a landmark object, or the tallest building may be selected as a landmark object. The invention may be so constructed that a user's desired building or the liker can be set as a landmark object by the user operating the vehicle navigation device 13. Three or more landmark objects may be selected.

In the above embodiments, the vehicle navigation device 13 generates image data small in data amount (S220). Instead, the microcomputer 10 of the in-vehicle unit 1 may generate image data.

The above embodiments may be so modified that the following is implemented: both image data and text data are generated; and both the image data and the text data are displayed on the display 27 of the portable unit 2. In this case, specifically, it is advisable to alternately display the image data and the text data on the display 27.

In the above embodiments, the vehicle navigation device 13 is so constructed that it generates the relative position information when it receives a request for relative position information from the microcomputer 10. The relative position information may be generated at any time points. For example, the relative position information may be periodically generated and stored in memory; and the relative position information may be read from the memory and transmitted to the microcomputer 10, when the request for relative position information is received from the microcomputer 10.

The second modification is so constructed that the relative position information is notified by sound, light, and vibration in addition to the display of an illustration or text. Instead, only any (or any combination) of sound, light, and vibration may be used to notify of relative position information.

The second embodiment and the third embodiment may be combined with each other. That is, the invention may be so constructed that the portable unit 2 includes the map generation unit 24, UHF receiver unit 23, and transmission/reception selector switch 29 and the in-vehicle unit includes the UHF transmitter unit 14.

The third embodiment may be so modified that the request for relative position information is transmitted in superimposition on the following: a command signal (e.g., a signal for commanding that the doors should be locked or unlocked) produced when the user operates the push switch 25 or 26; a command signal for commanding an engine start; or the like. The relative position information from the in-vehicle unit 1 may be transmitted in superimposition on an acknowledgement signal in response to the command signal from the portable unit 2.

Time when the command signal is transmitted from the portable unit 2 can be supposed to be time when the user is about to get into the vehicle. The user should be approaching the vehicle at least. When the relative position information is contained in an acknowledgement signal from the in-vehicle unit 1 at this time, the user can swiftly pinpoint the location of his/her vehicle. As a result, he/she can get into the vehicle at once and head for the next destination.

When the user operates the portable unit 2 to transmit such a command signal as mentioned above, it may be thought that the user should have a grasp of the location of his/her vehicle. But, this is not necessarily the case. As an example, a command signal for commanding an engine start will be taken. When warm-up is required in the winter season, the user will try to start the engine first of all even though he/she does not have a grasp of the location of the vehicle. Alternatively, not in the winter season, a user who considers that warm-up is important will do the same. Inclusion of relative position information in the acknowledgement signal is very useful for these cases.

The third embodiment may be so constructed that at S340, the radio waves in the LF band are also utilized to transmit relative position information. Specifically, a construction that relative position information is alternately transmitted in the UHF band and in the LF band is possible.

What is claimed is:

1. An electronic key system comprising:
an in-vehicle unit mounted in a vehicle; and
a portable unit carried by a user for executing radio communication with the in-vehicle unit for authentication by the in-vehicle unit, wherein:
the in-vehicle unit includes a position information transmitting section that transmits relative position information indicating a relative position of the vehicle in relation to a landmark object near the vehicle by radio communication; and
the portable unit includes a position information receiving section that receives the relative position information when the relative position information is transmitted from the in-vehicle unit, and a notifying section that notifies nearby people of the relative position of the vehicle.

2. The electronic key system of claim 1, wherein:
the in-vehicle unit further includes a transmission timing determining section that determines a transmission time point of transmitting the relative position information to a time point of a user operation on a predetermined part of the vehicle;
the position information transmitting section transmits the relative position information at the transmission time point; and
the portable unit stores the relative position information, when the relative position information is receviced from the portable unit.

3. The electronic key system of claim 1, wherein:
the notifying section includes a displaying section that displays an image representeding the relative position of the vehicle.

4. The electronic key system of claim 3, wherein:
the notifying section generates from the relative position information a picture representeding the relative position of the vehicle in relation to the landmark object, and displays the generated picture on the displaying section.

5. The electronic key system of claim 1, wherein:
the portable unit further includes a request information transmitting section that transmits request information indicating that the relative position information is requested;
the in-vehicle unit further includes a request information receiving section that receives the request information, when the request information is transmitted from the portable unit; and
the position information transmitting section transmits the relative position information, when the request information is received by the request information receiving section.

6. The electronic key system of claim 1, wherein:
the in-vehicle unit further includes a first in-vehicle unit side communicating section that communicates with the portable unit by radio waves in a first frequency band, and a second in-vehicle unit side communicating section that communicates with the portable unit by radio waves in a second frequency band different from the first frequency band;
the portable unit further includes a first portable unit side communicating section that communicates with the in-vehicle unit by radio waves in the first frequency band, and a second portable unit side communicating section that communicates with the in-vehicle unit by radio waves in the second frequency band;
the position information transmitting section utilizes at least either of the first in-vehicle unit side communicating section and the second in-vehicle unit side communicating section to transmit the relative position information; and
the position information receiving section) utilizes the first portable unit side communicating section to receive the relative position information when the relative position information is transmitted by radio waves in the first frequency band, and utilizes the second portable unit side communicating section to receive the relative position information when the relative position information is transmitted by radio waves in the second frequency band.

7. The electronic key system of claim 6, wherein:
the first frequency band is either of a LF band and a UHF band; and
the second frequency band is one of the LF band and the UHF band different from the first frequency band.

8. The electronic key system of claim 1, wherein:
the in-vehicle unit (1) further includes a transmission timing determining section that determines a transmission time point of transmitting the relative position information to a time point of a user operation on a predetermined part of the vehicle, and a request information receiving section that receives request information indicating that the relative position information is requested; and
the portable unit (2) further a request information transmitting section that transmits the request information;
the in-vehicle unit and the portable unit are configured to execute radio communication in two different frequency bands that include a first frequency band and a second frequency band by which a communication range is longer than by the first frequency band;
the request information receiving section and the request information transmitting section receive and transmit the request information by radio waves in the second frequency band; and
the position information transmitting section transmits the relative position information by radio waves in the first frequency band at the transmission time point, and transmits the relative position information by radio waves in the second frequency band when the request information is received.

9. The electronic key system of claim 1, wherein:
the relative position information indicates a direction of the landmark object relative to the vehicle and a distance therebetween; and
the direction of the landmark object relative to the vehicle is indicated with a front part of the vehicle taken as “forward.”

10. The electronic key system of claim 1, wherein:
the position information transmitting section selects a nearest building from the vehicle of buildings presented around the vehicle as the landmark object.

11. The electronic key system of claim 1, wherein:
the in-vehicle unit further includes a navigation device which normally provides predetermined data including calculated present position data and map data; and
the position information transmitting section transmits the relative position information in a form simplified from the predetermined data of the navigation device.

12. A portable unit for radio communication with an in-vehicle unit of an electronic key system, the in-vehicle unit being mounted in a vehicle and including a position information transmitting section that transmits relative position information indicating a relative position of the vehicle in relation to a landmark object near the vehicle, the portable unit comprising:
a position information receiving section that receives the relative position information when the relative position information is transmitted from the in-vehicle unit; and
a notifying section that notifies nearby people of the relative position of the vehicle.
